(19) United States
(12) Patent Application Publication
(10) Pub. No.: US 2011/0123698 A1
(43) Pub. Date: May 26, 2011

(54) PROCESS AND APPARATUS FOR PRETREATMENT OF FRESH FOOD PRODUCTS

(76) Inventor: James C. Meng, San Antonio, TX (US)

(21) Appl. No.: 12/735,835

(22) PCT Filed: Apr. 29, 2008
(86) PCT No.: PCT/US2008/005473

§ 371 Date: Aug. 20, 2010

Related U.S. Application Data
(63) Continuation-in-part of application No. 12/072,074, filed on Feb. 22, 2008.

(51) Int. Cl. A23B 7/00; A47J 23/00

(52) U.S. Cl. 426/418; 99/473

(57) ABSTRACT

A method and apparatus for pretreating a fresh food product to relieve the internal (turgor) pressure and adjust the product temperature Invention has an enclosure with an internal space, an air inlet and an air outlet An exhaust fan is in fluid communication with the internal space Rows of product containers are disposed on either side of the exhaust fan to form an airflow aisle with an open end. A cover extends over the airflow aisle and the open end to form an air plenum tunnel. The exhaust fan is activated to lower the air pressure within the tunnel and pull enclosure air through openings in and between the product containers and over and around the food product. The exhaust fan further circulates exhaust air over cooling coils and returns exhaust air to the internal space of the enclosure. An air conditioning mechanism is attached to the enclosure outlet

### BACKGROUND OF THE INVENTION

The present invention relates to an improved process and apparatus for pretreating fresh food products or produce prior to packaging or further and final processing. Most fresh fruits and vegetables are grown outside and exposed to considerable variances in environmental factors of light, temperature, humidity, moisture, and nutrient levels. When these factors combine resulting in accelerated growth conditions, high internal (turgor) pressures occur in the fruit or produce. High internal pressures also commonly occur in fruits and vegetables that are grown in the “forced” growth conditions employed in greenhouse environments.

Fresh fruit and vegetables, especially those grown under accelerated conditions, develop internal pressures sufficiently high to rupture cellular walls and epidural encasements resulting in interstitial cracks. Once cracks occur they not only have deteriorated cosmetic appearance, but also have released the enzymatic mechanism (Phenoloxidase) that begins the breakdown of the fruit. Additionally, a crack in the epidural layer and the ruptured underlying cells exposes the inner sugars, providing a fertile media for growth of molds, yeasts, and bacteria, which further breakdown the fruit.

For some products genetic manipulation has been explored to alter the nature of the produce, creating a product with a thicker epidermal layer or skin and more hardy cellular structure. These structural modifications to the plant can create fruit that can better contain the internal pressures until they are reduced by the natural moisture transpiration. The frequent consequence of this genetic manipulation is a product with less desirable flavor profiles and tactile mouth feel.

This transpiration of moisture for all fruits and vegetables begins upon picking and continues until the fruit or vegetable has either been used, processed or discarded. During the transportation and storage portions of the post harvest process, the transpiration of the product may be accelerated because of the lower humidity conditions resulting from the direct expansion refrigeration units used in these areas. Often the post harvest processing of fresh fruit and vegetables includes the application of oil or wax to seal the surface to slow the rate of moisture loss to extend the shelf life of the product.

Fruit and vegetables that are picked from the field during normal growing seasons are picked at the temperatures in the growing environment. Typically this is hot, on the order of 80, 90 or even 100+degrees. This product is said to contain “field heat.” Currently there are numerous ways that this heat is dealt with prior to inspection and packaging. These include: a) Let the product “rest” in the packing shed, with or without forced air ventilation, for a period of time generally ranging from several hours to over a day to allow some of the field heat to dissipate; b) Wash the product in cool water; c) Place the product in a forced air cooler; d) Place the product in a vacuum cooler; or e) Forced air evaporative cooling.

a) “Resting” the product.
It has been shown that prolonged exposure of the product to temperatures over 80° F. accelerates the breakdown of the product, causing it to lose firmness and shorten the shelf life. Additionally, product with high turgor pressures may spontaneously yield to the internal pressures resulting in cracking. This process is often made worse by micro damage occurring to the fruit as the result of the handling and transportation prior to the “resting” phase. Also temperatures in the packing sheds can often exceed 80° F. thereby minimizing the cooling effect and effectiveness of this method.

b) Hydrocooling or washing the product in cool water.
This is an effective method of dropping the temperature inside the product. Unfortunately when dealing with a product with high turgor pressure, the cooling effect is too rapid to allow the necessary slow conduction of heat to lower the core temperature. The effect of this rapid drop in temperature is that the exterior of the product cools more quickly and, as it cools, it shrinks. The shrinking of the exterior surface increases the internal pressure in the product, resulting in substantially increased incidence of cracking.

c) Forced Air Cooler or Conditioning Room.
The ultimate effect of this treatment, while potentially slower in effect than washing the product in water, also results in increased incidence of cracking. The existing technology typically produces a cooling effect by passing air across a direct expansion, cooling coil. The surface temperature of the coiling coil, which is determined by the expansion characteristics of the refrigerant, is well below the dew point of the air stream. This results in air with a very low dew point. This cold dry air both cools and dehydrates the product. The high temperature and vapor pressure differentials between the air and the product combine to rapidly shrink the outside layers first, and increase the core pressure within the fruit, resulting in cracking.

d) Vacuum Cooling.
This is used on certain fruits and vegetables with a high surface to mass ratio, things like lettuce, corn, celery, peppers, etc. For this process the product is put into a chamber and the pressure in the chamber is reduced thereby cooling the product by evaporation. The evaporation loss, which is primarily water, results in about 1% loss in weight for every 10° F. temperature loss. This method can also be combined with the use of refrigeration coils in the chamber. This method is ill advised for product with high internal pressures. As pressure in the chamber is reduced the differential between the pressure within the cells and the atmospheric (external) pressure becomes greater, splitting the fruit that is already at risk.

e) Forced Air Evaporative Cooling.
An alternative method for cooling products is the use of forced air through a cascade of falling water droplets or a mist spray. This method of cooling the product is often used because the equipment is much less expensive. The air is cooled by the releasing of its heat to the latent heat of vaporization of the moisture droplets. The air exits the cooler unit with a high relative humidity. Depending upon the humidity of the air stream, the product may be slightly cooled (on the order of about 10° F.) but at best little has been done to relieve the internal pressure. In most cases, the internal pressure is increased, which results in increased cracking.

The present invention seeks to safely and slowly relieve the internal cell pressure, while also adjusting the product to the desired processing temperature. This preprocessing of the produce is most effective when employed as quickly as possible after the harvest and before the cracks have formed. This effectively salvages fruit or vegetables that would otherwise be separated and discarded as waste. The producer is able to retain a greater portion of the product as saleable, than currently is possible.

A principle underlying this present inventive process and apparatus is controlling the temperature and humidity of the air media and then circulating that media to insure intimate contact with the surface of all the fruit or vegetables. The system is designed to separate the latent and sensible heat loads of the product so that the differential driving force can be controlled to remove the excess moisture and still be able to deliver the final desired product temperature. The current state of the art does not allow the separation of these functions. Failure to separate the two heat loads results in imbalance between the humidity and temperature resulting in overly aggressive environmental conditions which will either dehydrate the product too far and/or too quickly, or not allow the desired final product temperature to be attained.

A measure of the driving force between the recirculated air within the enclosure and the partial pressure of the moisture in the fresh produce is the vapor pressure deficit (VPD). It may be defined as the difference in the pressure exerted by the amount of moisture in the air and how much moisture the air can hold (also referred to as saturation pressure.) The saturation pressure can either be determined from a psychrometric chart or calculated. For the VPD to be calculated the ambient air temperature must be known and either the dew point temperature or the relative humidity must also be known.

When the temperature of the air and the source of transference are the same or similar, the vapor pressure deficit represents a much simpler and nearly straight-line relationship of the sum of evaporation and transpiration from plants or other measures of evaporation. It proves to be much more useful than merely looking at the relative humidity or grains of moisture per pound of dry air.

Thus, the vapor pressure deficit is the measure of the difference between how much moisture is in the air and how much it can hold when saturated. Vapor pressure vpₐᵢᵣ is a measure of how much water in the gaseous state is in the air. More moisture in the air translates to higher vapor pressure. The maximum amount of vapor content in the air for a given temperature occurs when the air is saturated, at the dew point, and is called the saturation vapor pressure or vpₛₐₜ. The difference between the saturated air vapor pressure and the actual air vapor pressure (vpₛₐₜ−vpₐᵢᵣ) is the definition of the vapor pressure deficit.

Higher VPD numbers occur at lower humidity levels when the air has a higher capacity (or affinity) for additional moisture. This corresponds to higher rates of water transference from the fresh produce or fruit. Lower VPD numbers occur at high humidity levels, whenever the air is at or near saturation and cannot accept additional moisture. This corresponds to lower rates of water transference from the fresh produce or fruit.

One method for calculating saturation vapor pressure has been proposed by Jessica J. Prenger and Peter P. Ling in the 2000 Ohio State University Extension Fact Sheet, entitled Greenhouse Condensation Control: Understanding and Using Vapor Pressure Deficit (VPD) AEX-804-01 uses the Arrhenius equation, directly from the temperature. This equation is:

vpₛₐₜ=e^{(A/T+B+CT+DT2+ET3+FlnT)}

This equation can be used to determine the vapor pressure for both the general condition temperature in the enclosure and at the dew point temperature. If the temperature of the air and the temperature of the fruit are significantly different, calculating the vapor pressure at the temperature of the fruit as an approximation may be used to gain insights into the nature of the transference between the fruit, the boundary layer, and the recirculated air.

The vapor pressure in the air vpₐᵢᵣ is determined by multiplying the measured relative humidity (RH) times the vpₛₐₜ. The difference between vpₛₐₜ and vpₐᵢᵣ is the calculated value of the vapor pressure deficit (VPD). The converse of that equation that is also useful is that the relative humidity (RH) is equal to (vpₐᵢᵣ/vpₛₐₜ).

If the air temperature and dew point are measured, the relative humidity can be determined by dividing vp_{dew} by vpₛₐₜ . Alternatively, the dew point can be determined using a psychrometric chart, well known in the art (see FIG. 12.2, page 12-5, Perry's Chemical Engineering Handbook, 7^{th} Edition, by Robert H. Perry and Don W. Gran, New York, McGraw/Hill (1997).)

The vapor pressures and vapor pressure deficit may also be derived using a modified psychrometric chart, as shown in FIG. 4, which was prepared using the Arrhenius equation to calculate the saturated vapor pressure (Relative Humidity=100%) for the different temperatures and then using the equation vpₐᵢᵣ=Relative Humidity X vpₛₐₜ to calculate the vapor pressures at the different relative humidities along the constant temperature lines.

Typically, existing analytical instruments may be used to determine the relative humidity and dew point temperatures.

Adjusting the differential between the partial pressure of the moisture within the produce and the relative humidity in the air media surrounding the product controls the rate of moisture transference between the product and environment. This relieves the turgor pressure without rupturing the cellular structure. The rate of transference is controlled to allow diffusion through the semi-permeable membranes of the cells from the core to the epidural layers of the fruit or vegetable.

Different products require different transpiration rates to relieve the turgor pressure without drying and shrinking the epidural layers too quickly, and causing cracking. Depending upon the product, the desired VPD is in the range of approx. 0.5 to approx. 3.0 kilopascals. A principal objective of the present inventive system is to provide a means for achieving the desired VPD for any selected product.

The airflow must insure intimate contact with the surface of the fruit or vegetable. This is accomplished using a high volume of forced air movement around the produce, effectively washing away the surface boundary layer of heat and moisture. Failure to provide a sufficiently high velocity across the fruit or vegetable allows the development of a saturated boundary atmosphere at the food's surface and a retarded migration rate.

The present invention reduces the specific volume of the moisture within the cells to lower the internal cellular pressure and is capable of removing the field heat of the product. The combined effect of these two desirable outcomes effectively stabilizes the fruit, allowing normal handling with minimized probabilities of further deterioration or cracking.

The inventive process is terminated whenever the percent moisture loss required to stabilize the produce has been achieved. Dependent upon the nature of the product, the normal percent of moisture loss required is on the order of 0.20% to 2.0%. Normally moisture is transpired from the fruit or vegetable during shipment and storage prior to being consumed or used. But this invention allows the initial portion of that moisture to be removed in a controlled manner before the product at risk has cracked. This results in improved yields and improved finished product quality.

The beneficial effects of the present inventive process on the treated produce are increased firmness, increased retention of firmness, increased shelf life, reduced damage in transit, and reduced damage during post picking inspection, sorting and packaging. Products that are picked with vine or stem and processed using this invention also have improved attachment retention.

Internal pressures when present make the produce (fruit or vegetable) more susceptible to damage from micro abrasions and point concentrated impact, which are typical during processing. When excessive internal pressures are present within the fruits or vegetables, these incidental conditions can sufficiently compromise the structural integrity of the containing encasement. When the internal pressures exceed the containment strength of the compromised skin, the produce will pop open (crack).

Use of the present inventive process and apparatus has no deleterious effect on color, texture, taste, pectins, nutritional values, and volatile flavor components. Because this process is a low temperature process, it may also be used to concentrate the nutritional elements, flavor components, vitamins, and sugars to higher levels than as picked. Since the process is a tightly controlled process for moisture removal, it could be used to dehydrate or dry the product without loss of cell structure or definition.

The process is well suited for use with fruit and vegetables that are greenhouse, hydroponically, or otherwise grown under environmentally controlled conditions.

It is also envisioned that the present invention may be applied to field grown produce/vegetables that have been subjected to environmental conditions which resulted in growth spurts. If the internal pressure peaks, the portions of the crops that would be most prone to cracking could be picked. The process could be used to decompress the fruit and allow subsequent ripening to salvage portions of the crop that would otherwise be lost.

### SUMMARY OF THE INVENTION

A primary function of the present invention is to control the differential between the partial pressure of the moisture in the product and the vapor pressure of the humidity in the surrounding air. This is done through the controlled removal of the excess moisture present in the air volume surrounding the produce at the starting environmental conditions and the moisture released from the produce by the transpiration loss induced by the process.

Another function of the present invention is to control the effect of the temperature on the internal pressure of the produce. If the temperature of the produce is reduced too rapidly, it will result in shrinking of the outer layers faster than the inner layers. The rate of temperature reduction must be sufficiently slow to allow thermal conduction of the heat within the fruit so that the temperature differential between the inner and outer layers of the fruit or vegetable are minimized. The effect of reducing the temperature too quickly is similar to taking a piece of fruit in hand and squeezing it until the internal pressure is increased and the fruit ruptures.

The inventive process is intended to control the environment and final temperature of the product so that it is above the dew point in subsequent inspection and packaging operations. If the temperature of the produce, when it is presented to subsequent packaging and processing operations, is below the dew point, moisture will condense on the product and could cause the re-absorption of moisture into the product. Moisture that has condensed on the surface of the fruit picks up dirt and juices from the handling equipment. These contaminants foster mold, yeast, and bacterial activity. Processing produce having temperatures below the dew point effectively slows or kills the migration of moisture from within the product, and may result in absorption of additional moisture.

In its present embodiment, the process utilizes heating (captured waste heat from the process) to increase the temperature of the produce to above the dew point if required. This is important for products that are winter grown (as in greenhouses) or where temperature conditions vary significantly during the course of a picking and packaging day.

The present inventive system is a closed loop system. Air is forced past the product. This air is contained and run through an axial vane fan, which provides the force to blow the air across the cooling coils to remove the field heat from the product. A separate side air stream is sent to a separate unit to remove the excess moisture from the air stream. The separation of the two sub-processes allows the separation of the latent heat load (removing the moisture) from the sensible heat load (removing the field heat).

### BRIEF DESCRIPTION OF THE DRAWINGS

FIG. 1 is a schematic illustration of the present inventive apparatus.

FIG. 2 is a more detailed drawing of an embodiment of the present invention showing the tarpaulin cover over the product containers, the dehydrator, recycle heater/cooler, and the return, conditioned air blower.

FIG. 3 is a schematic drawing showing various sensors used in an alternative embodiment of the present invention.

FIG. 4 is a Vapor Pressure Value Psychrometric Chart.

### DETAILED DESCRIPTION OF THE INVENTION

The present invention is a process and an apparatus which utilizes controlled atmospheric conditions of an air medium to effect a controlled decompression of the turgor pressure within fruit and vegetables, while simultaneously adjusting (either increasing or decreasing) the temperature of the produce to the optimal conditions required for further inspection, processing or packaging.

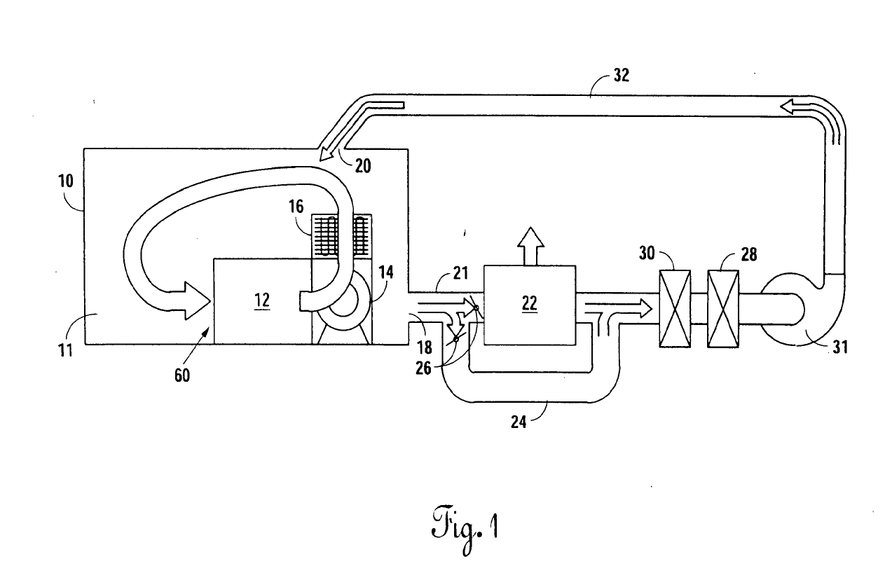

Turning to FIG. 1, the major components of the system are illustrated. An enclosure 10, having an internal space 11, is provided with a product holding station 60, an exhaust fan 14, sensible heat removing cooling coils 16, an air outlet 18, an air inlet 20, and a recycle duct 21. The moisture removal (dehumidification) subsystem includes a dehydrator 22 with a modulating bypass duct 24 with control dampers or valves 26. The inventive process and apparatus may either add heat with a heating unit 28 or cool the dehydrated air with a cooler 30. The conditioned air is then directed by a blower 31 from a second end 32 of the recycle duct 21 to the air inlet 20 in the enclosure. The system is a closed loop air circulation system.

A first sub-system includes the closed loop air circulation system within the enclosure 10. Conditioned air is forced past the product 12 (usually retained in bins 12a) to ensure intimate contact with the surface of the fruit or vegetable to effectively “wash” away the surface boundary layer of concentrated moisture and heat that have been released from the product. This circulation system must also address the air distribution requirements to ensure reasonably uniform delivery of air to and around all the pieces of product 12.

Cooling coils 16 are intended to remove only the field heat (sensible heat) from the product. This sub-system is designed to remove the field heat from the product without also removing the latent heat of vaporization for the moisture released from the fruit. The surface temperature of the cooling coils is controlled to prevent the attainment of temperature at or below the dew point of the circulated air. Controlling the temperature of the cooling coils can be accomplished several ways, including:

1. Installing a backpressure pressure regulation valve in the refrigerant gas return line in the condensing unit to reduce the pressure drop across the expansion valve;

2. Using a thermostatic expansion valve (TXV) with the temperature sensor being located on the surface of the coil; or

3. Using a modulating control valve to electronically sense the temperature of the coil and adjust flow of refrigerant through the expansion valve.

The moisture level of the air stream sweeping over the product as measured by the relative humidity or grains of moisture per pound of air must be controlled. This is done using a slipstream of air withdrawn from the enclosure that is dehumidified and reintroduced into the main circulation air stream.

The control of the migration of moisture from within the fruit is based upon a “water activity” ratio between the partial pressure of the water vapor in the air surrounding the produce to the vapor pressure of the free water within the fruit. There is a differentiation between the free moisture and what is otherwise bound to the fruit constituents.

The mass transfer is dependent upon:

1. The surface area of the fruit;

2. Removal of the boundary layer of the water vapor from the surface;

3. Sustained driving force between the inner to the outer subsequent layers of the fruit or vegetable; and

4. Sustained driving force between the outer boundary layer of the fruit or vegetable and the surrounding air stream.

The present inventive process also includes a dehydration sub-system which reduces the moisture levels in the main circulating air stream. The moisture in the main circulating air stream comes for the atmospheric environment in the internal space 11, and the moisture released from the product 12. This sub-system involves a slipstream of air removed from the environment and after conditioning is reintroduced into the enclosure and the main circulation air stream.

The regulation of the humidity of the slipstream may be accomplished a number of ways. These include, but are not necessarily limited to:

a. Desiccant drying—Control of the humidity of the slipstream is achieved by a modulated splitting of this stream so that all or part of it flows through the desiccant and the remaining portion of the flow is routed around the desiccant unit. These two portions are then recombined and mixed to produce the desired moisture level in the slipstream air. This slipstream subsystem may be either a low-pressure system (operated at pressures on the order of 2″ to 6″ of water column) to a high-pressure system (operating at several pounds per square inch).

b. Compression, refrigerated drying, and decompression—A portion of the air stream removed is compressed, the moisture is removed using a refrigerated dryer to remove the amount of moisture being generated by the process. The air is then decompressed and reintroduced into the main circulation air stream. Flow to this unit is modulated through the air intake modulated bypass valves and/or starting and stopping of the units.

c. Cooling, moisture condensation, and reheating—A portion of the air stream is removed and blown across a cooling coil that effective lowers the temperature of the air to a temperature at or below the dew point of the air stream. The temperature of the coil controls the moisture removal. Further modulation can be effected by adjusting the amount of airflow across the coil.

If a desiccant wheel is used as the means of dehydration, it has the additional benefit of sterilization of the air slipstream. During the regeneration cycle, the temperature of the wheel is heated to between 250 and 350° F. This sterilizes the surface of the wheel. Additionally, the air stream that passes over the regenerated wheel is heated up also. This waste heat may be used to warm the product.

Whenever the temperature of the produce is low, raising the temperature assists in the reduction of the internal pressure because of the thermal coefficient of expansion. The volume of the fruit gets larger, thereby reducing the pressure within the fruit or vegetable.

Depending upon the temperature of the produce in the product station 60, the inventive process either adds heat, if necessary, from external sources such as a heating coil or from utilization of waste heat generated in the latent heat removal system or the dehumidification system, to increase the temperature of the product above the ambient dew point in the production area.

Various system monitors and controls are provided to measure and adjust the system humidity and temperatures to meet the requirements of the fruit or vegetables being pretreated.

While the present description illustrates an enclosure 10, there may be various other environmental containment options. These may include an enclosure or a tunnel(s) with various zones to isolate the process from external conditions which would alter the differential driving forces (temperature and humidity) established between the produce and the process.

The scope of this invention is such that it may be employed as a 1) batch process; 2) as a continuous transportation process with various chambers of progressively different temperature and humidity environments; or 3) as a mobile trailer mounted process that could be transported to the field or farm to increase the good yield of the product being picked.

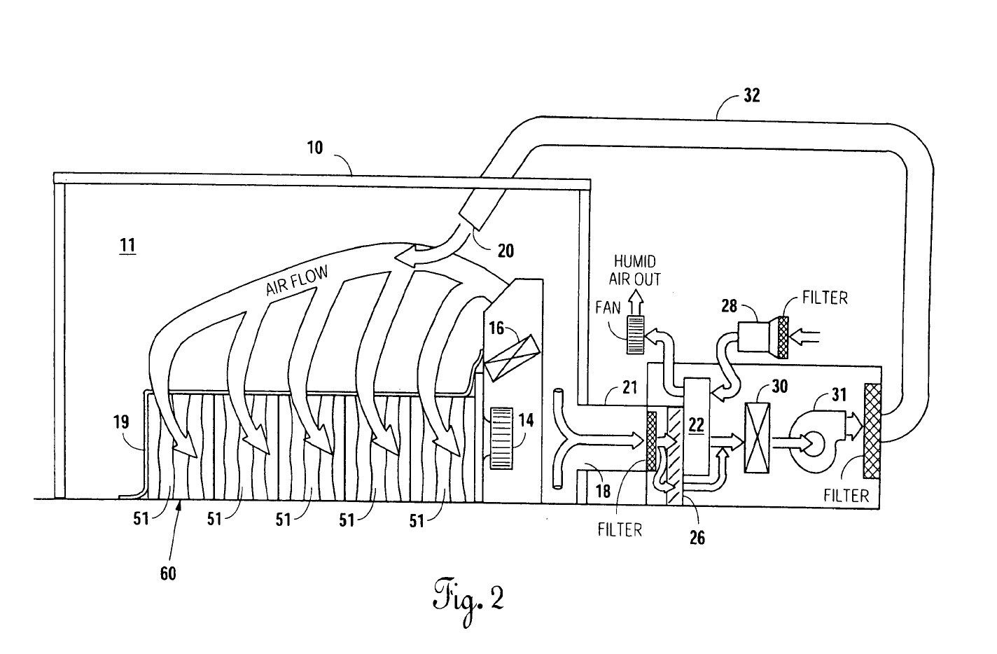

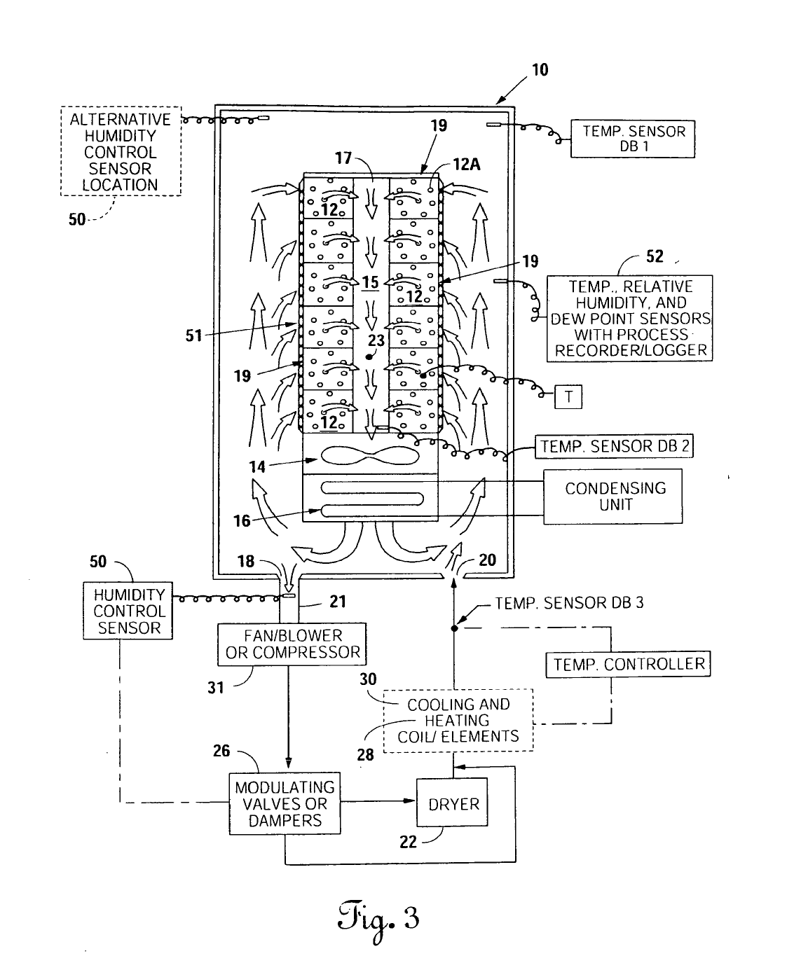

FIGS. 2 and 3 illustrate an embodiment of the apparatus and process of the present invention. The process includes providing an enclosure 10 or containment environment having an internal space 11 wherein the temperature and relative humidity may be controlled. The enclosure is provided with an air inlet 20 and an air outlet 18 and a product station 60 where bins or containers 12a of fresh fruit or vegetables 12 may be placed in spaced apart rows on either side of an exhaust fan 14 at one end of the enclosure. The rows form an airflow aisle 15 with one open end 17. A tarp or cover 19 (FIG. 2) is extended over the product station, across the tops of the produce bins 12a, along the sides of the product bins 12a, and over the open end 17 to form an air plenum tunnel 23. The cover 19 has side curtains 51 that may be designed to have varying percentages of open area to allow similar volumes of air to pass, across the product 12 in bins 12a, and into the plenum tunnel 23 from all bin 12a positions along the rows, when the exhaust fan 14 is activated. The cover is intended to prevent air short-circuiting either into the tops of the bins or at the ends of the rows. In FIG. 3, the top portion of the cover 19 is not shown for clarity purposes.

Sensors and controllers (FIG. 3) measure the following:

a. Product temperature T—This determines whether the product needs to be heated or cooled during this process to attain the predetermined exit temperature set point. It also serves as an indication of the water activity within the product. Samples are pulled and weighed at various intervals through the pretreatment process to determine the total percentage moisture loss during the process (preferably in the range of 0.20%-2.0%) and also to determine rate of moisture loss. Methods to determine this temperature include destructive insertion of a temperature probe into several randomly selected samples of the produce or non-destructively using a handheld infrared thermometer. In one embodiment of the invention, the product temperature is approximated, when the system is running, by air stream temperature sensor DB2. Additional embodiments utilize a series of infrared sensors to even more accurately determine the product temperatures.

b. Temperature, relative humidity, and dew point within the enclosure are recorded as the starting point and monitored throughout the process via sensor/recorder 52.

c. Temperature, relative humidity, and dew point in the production area (not shown) are measured. The production area is where the product will be further processed or packaged. These factors determine the desired final temperature of the product. Normally this will be at the controlled temperature of the production environment, or 5 to 10 degrees above the dew point of the production area.

d. Humidity sensor 50 located in the air duct 21 is used to sense the humidity of the air slipstream and adjust the modulation of the dehumidifier controls to maintain a desired humidity set point or profile.

e. Temperature (dry bulb) DB1 of the volume of air in the enclosure is used to set the minimum temperature differential to be allowed for cooling the product.

f. Temperature (dry bulb) DB2 of the air that has passed over the product. This may be used as the set point of the desired final product temperature.

g. Temperature (dry bulb) DB3 of the air slipstream that has passed through the dehumidification process and the cooling 30 or heating 28 coils. This is used to control the operation of these coils to either provide a neutral temperature effect from the dehumidification process, or to adjust the rate of further removal or addition of heat to the process.

Depending upon the structural characteristics of the product, the process of relieving the product turgor pressure using this invention is usually on the order of 1 to 3 hours.

The operator sets the desired relative humidity to be maintained or, in cases where the temperature of the fruit and the enclosure are significantly different, he may set a relative humidity removal profile, and he sets the final temperature set point or temperature profile to be followed during processing to control the rate and extent of moisture loss from the produce. He then sets the control from sensor DB2 at the desired final temperature of the product and sensor DB1 at slightly (approximately 5 degrees) below the desired final temperature, if the product is to be cooled, or slightly above the desired final temperature if the product is to be heated. The exhaust fan 14 is started, which also initiates the refrigeration condensing unit if product cooling is required.

The temperature of the sensible heat removal cooling coil 16 is adjusted to maintained a coil temperature above the dew point.

The dehydration unit is set for the desired relative humidity within the enclosure. The temperature and relative humidity sensor 50 for this unit may either be located within the enclosure (as noted in broken lines in FIG. 3) or in the air duct 21 from the enclosure 11.

The dehydrator 22 and its recirculation fan are started (FIG. 2). The level of dehydration is controlled by modulating the air slipstream to either direct it through the dehydration unit, or to bypass 24 a portion of it around the dehydration unit.

The process continues until the pre-weighed samples have achieved the desired level of moisture loss required to prevent or reduce product cracking to an acceptable level and the final product temperature is achieved. At this point the exhaust fan 14 and its condensing unit 16 are turned off The dehydrator 22 and its recirculation fan are turned off or switched to a standby mode.

Finally, the pretreated product is removed from the enclosure and moved to the production area.

It should be understood that in the current process, if the initial temperature of the product while in the enclosure is below the dew point of the production area, waste heat and/or a heater 28 are used to adjust the temperature of the air in the enclosure to achieve the desired product temperature. If the product needs heat, the enclosure room temperature (DB1) will determine the cutoff point of the heater coil 28. If the product does not require heat or if the product requires cooling, then the discharge temperature (DB3) is controlled to adjust the cooling coil 30 to match the temperature in the enclosure 11. If the product requires the removal of field heat, the cooling coils 16 are used to adjust the exhaust temperature of the air reintroduced into the enclosure.

Two examples are provided to illustrate the process, one shows a condition where the product must be cooled and the second where heat must be added to raise the product temperature.

### EXAMPLE 1

Product start temperature=90° F.

Enclosure environmental conditions:
Temperature=90° F.
Relative Humidity=70%
Dew Point=81.4° F.

Production area environmental conditions:
Temperature=75° F.
Dew Point=66° F.
Relative Humidity=65%

Desired Results:
Product temperature above production area dew point of 66° F.;
therefore, set target temperature at 72° F. (Range 5°-10° F.)
Lower product temperature from 90° F. to 72° F.
Optimal processing vapor pressure deficit for selected product=2.0 kpa
(Range about 0.5 kpa to about 3.0 kpa)

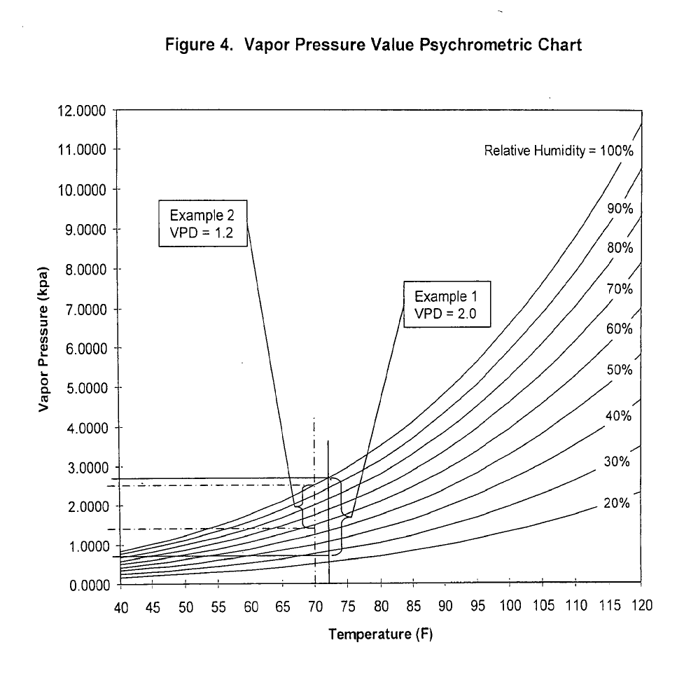

Calculations (from FIG. 4):
vpₛₐₜ at 72° F. from FIG. 4 is 2.7
vpₐᵢᵣ=2.7−2.0=0.7 (target in enclosure)
From FIG. 4, 0.7=25% RH (relative humidity)

Therefore, the operator would take the following actions:
Set point for removing sensible heat (FIG. 1, 2 & 3—Coil 16—Temp Sensor DB1)=68° F.
Cut off temperature (FIG. 3—Temp Sensor DB2)=72° F.
Set point for moisture removal unit (FIG. 1, 2, & 3—Dryer 22—Humidity Control Sensor 50)=25.0%
Set dehydrator cooling coil 30 for neutral effect Tₒᵤₜ (Temp Sensor DB3)=Tᵢₙ (Temp Sensor 52) In this case, the operator does not want to add heat into the enclosure from the dehydrator.
Process is complete when the desired temperature (72° F.)has been reached and the desired % moisture loss (approximately 0.2%-approximately 2.0%) has been achieved.

### EXAMPLE 2

Product start temperature=55° F.

Enclosure environmental conditions:
Temperature=60° F.
Relative Humidity=70%
Dew Point=55° F.

Production area environmental conditions:
Temperature=70° F.
Relative Humidity=70%
Dew Point=64° F.

Desired Results:
Product temperature above production area dew point of 64° F.;
therefore, set target temperature at 70° F. (Range 5°-10° F.)
Raise product temperature from 55° F. to 70° F.
Optimal processing vapor pressure deficit for selected product=1.2 kpa
(Range about 0.5 kpa to about 3.0 kpa)

Calculations (from FIG. 4)
vpₛₐₜ at 70° F. (from FIG. 4) is 2.5 kpa
vpₐᵢᵣ=2.5−1.20=1.3 (target in enclosure)
From FIG. 4, 1.3=47% RH

Therefore, the operator would take the following actions:
Sensible heat removal is not required; the product is already too cool. Set point for removing sensible heat (FIG. 1, 2 & 3—Coil 16—Temp Sensor DB1)=off.
Cut off temperature (FIG. 3—Temp Sensor DB2)=off. (Coil is off, but fan does run.)
Set point for moisture removal unit (FIG. 1, 2, & 3—Dryer 22—Humidity Control Sensor 50)=47%
Dehydrator cooling coil 30 is not required; the fruit is already cool. Set for using Temp Sensor 52=72° F. (as precaution or off).
Allow waste heat from the dehydration process to raise the temperature. Set dehydrator heating coil (FIG. 3—Heating coil 28) using Temp. Sensor DB3 to (75°-80° F.) to gradually raise the temperature of the enclosures and the fruit.
Process is complete when the desired temperature (70° F.) has been reached and the desired % moisture loss (approximately 0.2%-approximately 2.0%) has been achieved.

While the system and method of this invention have been described in terms of preferred embodiments, it will be apparent to those of skill in the art that variations may be applied to the systems, methods, and in the steps or in the sequence of steps of the method described herein without departing from the concept, spirit and scope of the invention. More specifically, it will be apparent that certain materials that are both functionally and mechanically related might be substituted for the materials described herein while the same or similar results would be achieved. All such similar substitutes and modifications to those skilled in the art are deemed to be within the spirit, scope and concept of the invention as defined by the appended claims.

1. An apparatus for pretreating a fresh food product comprising:
an enclosure having an internal space, an air inlet and an air outlet;
an exhaust fan in fluid communication with said internal space;
first and second spaced apart rows of product containers disposed on either side of said exhaust fan to form an airflow aisle with an open end;
a cover extending over said airflow aisle and said open end to form an air plenum tunnel;
said exhaust fan adapted to lower the air pressure within said tunnel and pull enclosure air across said fresh food product, said exhaust fan further adapted to circulate exhaust air over cooling coils to remove sensible heat from said product and return said exhaust air to said internal space;
an air conditioning mechanism attached at a first end to said enclosure outlet, said mechanism adapted to
a) dehydrate a withdrawn portion of said enclosure air in response to a predetermined relative humidity set point for said fresh food product;
b) adjust the temperature of said withdrawn portion of said enclosure air to achieve a predetermined temperature set point for said fresh food products; and
c) return at a second end of said conditioning mechanism said conditioned portion of said withdrawn air to said internal space through said air inlet.

2. The apparatus of claim 1, wherein said air conditioning mechanism further comprises:
a modulating bypass duct to bypass a first selected portion of said withdrawn air around or through a dehydrator to provide a dehydrated air portion;
a recycle heater or cooler for selectively heating or cooling said dehydrated air portion; and
a blower assembly for producing a lower air pressure at said first end than at said second end and for directing said heated or cooled, dehydrated air portion through said air inlet in said enclosure into said internal space.

3. A process for pretreating a fresh food product to relieve turgor pressure of said product through controlled moisture removal comprising the steps of:
providing an enclosure having an internal space and an air inlet and an air outlet;
disposing at one end of said enclosure an exhaust fan;
placing first and second, spaced-apart rows of product containers having fresh food product therein on either side of said exhaust fan to form an air flow aisle with an open end;
extending a cover over said airflow aisle and said open end to form an air plenum tunnel; activating said exhaust fan to lower the air pressure within said tunnel to draw enclosure air toward a low pressure zone in said tunnel thereby sweeping enclosed air over said fresh food product;
circulating said swept enclosure air over cooling coiling to achieve a temperature controlled exhaust air temperature;
returning said exhaust air to said internal space;
withdrawing from said internal space a portion of said enclosure air for conditioning;
passing said withdrawn air through a dehydration mechanism sufficiently to modify the relative humidity of said withdrawn air in response to a predetermined relative humidity set point for said fresh food product within said internal space;
adjusting the temperature of said withdrawn air sufficiently to modify the temperature of said withdrawn air to achieve a predetermined temperature set point for said fresh food product; and
returning said conditioned air to said internal space to mix with said enclosure air.
